(19) United States
(12) Patent Application Publication
(10) Pub. No.: US 2024/0073353 A1
(43) Pub. Date: Feb. 29, 2024

(54) VIDEO FEED MASKING BASED ON DEVICE RECOGNITION

(71) Applicant: Rods&Cones Holding bv, Amsterdam-Duivendrecht (NL)

(72) Inventors: Jan DHEEDENE, Vosselaar (BE); Bruno DHEEDENE, Amsterdam (NL); Benoit QUIRYNEN, Amsterdam-Duivendrecht (NL); Dario VULJANIC, Amsterdam-Duivendrecht (NL); Dalibor KOFJAC, Amsterdam-Duivendrecht (NL)

(21) Appl. No.: 17/893,744

(22) Filed: Aug. 23, 2022

(51) Int. Cl. H04N 5/272; G06T 11/00; G06V 10/22; G06V 10/26; G06V 20/40; G06V 20/62; H04L 12/18

(52) U.S. Cl. CPC H04N 5/272; G06T 11/00; G06V 10/235; G06V 10/267; G06V 20/41; G06V 20/46; G06V 20/63; H04L 12/1822; G06V 2201/034

(57) ABSTRACT

Capturing, masking and transmitting video feed from a medical unit in a videoconference can be performed with one or more remote users and preferably a local user in proximity to the medical unit. The method includes steps for the identification of the medical unit being used, creation of masks suitable to mask patient information, overlaying said mask to the original video feed and providing a single masked video feed. A system can be suitable to connect to receive input from a medical unit, apply the abovementioned method and provide the produced masked video feed to a videoconference system.

### FIELD OF THE INVENTION

The present invention relates to a system and method for capturing, processing and transmitting of video and audio feed from medical units. The present invention pertains to the technical field of electronic communications, more in particular, the present invention relates to the technical field of selective content distribution.

### BACKGROUND

Such a device/composition according to the preamble is also known from CN105472470. CN '470 further describes a medical treatment live broadcast system based on patient privacy information filtering. The system comprises a control unit, a collection unit used for collecting medical information data and a filtering unit used for processing patient privacy information in the medical information data. The system further includes a text recognition module, an image recognition module and an audio recognition module. Text, video and sound filtering modules make inaccessible any information deemed sensitive.

Reading and/or storage of private data in machine readable format for any length of time exposes disadvantageously facilitates malicious gathering and processing of said private data. The aim of the invention is to provide a method which eliminates those disadvantages. Therefore, there is the need for a system which avoids reading and/or storage of private patient information yet still permits controlling the amount of information stored and/or disclosed via one or more video and audio feeds. More relevantly, these objectives should be attained while maintaining low processing power and bandwidth requirements.

### SUMMARY OF THE INVENTION

The present invention and embodiments thereof serve to provide a solution to one or more of above-mentioned disadvantages. To this end, the present invention relates to method for capturing, masking and transmitting video feed from a medical unit.

Preferred embodiments of the device are shown herein. Specific preferred embodiments relate to an invention, wherein, each mask is associated with multiple types of data suitable to identify a specific model and/or type of medical unit. In this way, once a type and/or model of medical unit has been used once, identification of said medical unit and retrieval of a suitable mask are advantageously made faster. The resulting masked video is transmitted to videoconference system as a single feed, which advantageously keeps the masked video feed size the same as that of the original feed provided by the medical unit, thus avoiding the need for more bandwidth.

In a second aspect, the present invention relates to a system including a filtering unit. More particular, the system as described herein provides that at least one memory is provided, which memory includes the method of claim 1.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 presents a preferred embodiment of the method for capturing, masking and transmitting video feed and its comprising steps.

FIG. 2 presents a preferred embodiment of the system for capturing, masking and transmitting video feed.

### DETAILED DESCRIPTION OF THE INVENTION

The present invention concerns a method for capturing, masking and transmitting video feed from a medical unit in a videoconference with one or more remote users and preferably a local user in proximity to the medical unit. The method is further supported by a system for capturing, masking and transmitting video and audio feed from at least one medical unit. The present invention permits providing a video feed from a medical unit and a content occluding mask in a single video feed, thereby maintaining bandwidth requirements for the transmission of said video feed. This effect is particularly advantageous in situations such as, but certainly not limited to, distance learning and online scientific conferences where limited bandwidth is often an issue.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g., component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any 3, 4, 5, 6 or 7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

A method for capturing, masking and transmitting video feed from a medical unit in a videoconference with one or more remote users and preferably a local user in proximity to the medical unit, the method comprising the steps of:
a. receiving a signal via at least one channel from at least one medical unit, said signal comprising at least the video feed, with said video feed comprising patient information, preferably text-based patient information;
b. identifying the model and/or type of medical unit;
c. generating or retrieving a mask from a mask database based on the model and/or type information;
d. merging the mask with at least some, preferably all, frames of the video feed; and
e. sharing, and preferably displaying, the merged masked video feed via the videoconference;

wherein, the masks are configured for overlaying at least some, preferably all, of the patient information. The method is applicable to any medical device capable of directly providing a video feed signal and/or other signal which provides or can be converted to a video feed. Such devices include, but are not limited to, EKG, MRI, Ultrasound, Fluoroscopy, tomography and x-ray. The method permits providing a single masked video feed which advantageously does not increase the size of the bandwidth requirements when compared with the unmasked video feed, while allowing for a confidential or redacted version to be shared in the videoconference. In many cases, medical unit images comprise data regarding the patient, whether it be name, weight, etc., that are not relevant to the procedure for remote experts. Not only can the sharing of this information constitute a breach of privacy, it can also detract from the actually medically relevant information on the images, and confuse or reduce concentration of the remote experts. In order to overcome all of the above issues, the images are therefore masked to block (part of) said data. By performing the masking prior to transmission, a higher degree of data security is provided as the unmasked data is never available to a broader public.

In order to advantageously expedite the generation a masked video feed, the identification information of each medical unit is stored in a medical unit database, wherein, each entry of the database further includes at least the model and/or type of the medical unit, by preference, manufacturer, serial number and/or media access control (MAC) address, and software version information of said medical unit are also stored in said database. More preferably, during the step of identification of a new medical unit, a sample of the signal transmitted by said unit is captured and associated with the unit information in the medical unit database. Most preferably, a sample of the signal is captured and stored in said database each time said or another unit of the same type/model is identified. In this way, a number of signal samples is collected for each medical unit, which signal samples can advantageously be used to train a machine learning algorithm. Said machine learning algorithm can then be used to automatically identify the medical unit.

Due to variations in the circuit construction used by each type of medical device and even in variations within the tolerance range of individual component used in identical models of medical units, video signals tend to exhibit variations inherent to the device generating said signals. In a further embodiment, the step of identifying the model and/or type of medical unit is carried out by comparing the fingerprint of the signal received in step a) with medical unit signal fingerprints stored in a medical unit signal fingerprint database. By preference, at least one such signal fingerprint is included in said signal fingerprint database. By preference a machine learning algorithm is trained using previously acquired signals from an individual machine unit, by preference, multiple identical machine units of the same model/type. The machine learning algorithm is preferably, but not limited to, a convolutional neural network (CNN) algorithm. These signal fingerprints advantageously permit automatic identification of previously used medical units.

In a further or another preferred embodiment, the step of identifying the model and/or type of medical unit is carried out by analyzing the lay-out of images of the video feed. The layout of the images of the video feed provides information that can be interpreted by either the user and a computer system, by preference, both by the user and the computer system. In this way, errors in the identification of the medical unit are advantageously avoided. More preferably, and if a mask matching the identified medical unit is available, said mask is retrieved and presented to the user, most preferably, said mask is presented to the user side by side and/or overlapping the layout of images of video feed. In this way, the user is not left doubting if the retrieved mask is the correct one for the video feed provided by the medical unit.

In some cases, such as when a new medical unit is used for the first time, no medical unit information is yet available. Therefore, in a further embodiment, a mask is created if no explicit model and/or type information for the medical unit is retrieved from the received signal and no model and/or type of the medical unit can be recognized. In a further embodiment, the creation of a mask includes the step of identifying the zones containing patient information, such as text, in the layout of the images in the video feed.

In this context, text is to be understood as any alphanumeric character, both with or without accents, either isolated or grouped together with other such characters, punctuation marks and/or special characters such as, but not limited to, ″, #, $, %, &, ′, *, +, −, /.

In a further embodiment, the user is requested to carry out the step of identifying the zones containing patient information, such as text, in the layout of the images in the video feed, which step is carried out by manually drawing bounding boxes around each word, said bounding boxes defining the areas to be masked. By preference, the step of identifying the zones corresponding to text (and/or other patient information) in the layout of the images in the video feed is carried out using a computer implemented segmentation algorithm, which algorithm creates bounding boxes around each word, which bounding boxes define the areas to be masked.

By preference, a subsequent step of grouping at least two of the identified single word containing zones is caried out. More preferably, this subsequent step is carried out by selecting individual single word containing zones and/or manually drawing bounding boxes around multiple single word zones in order to form multiple word zones. Yet more preferably, at least one single or multiple word zone is assigned an information class. Most preferably, the user is asked to assign user access privilege information to each single or multiple word zone. In this way, authorized practitioners may select different levels of patient information disclosure during generation of the masked feed. For example, the authorized practitioner may select masking of all patient information, in order to provide a masked video feed for a lecture to students, while the same practitioner may want to generate a masked video feed which discloses more patient information while consulting with other practitioners over videoconference.

In this context, an information class is to be understood as type of information which describe and/or quantify a single parameter (e.g., name, age, weight, height) which parameter identifies and/or describes a patient, device or event.

In a further embodiment, the generated masks are associated to a specific signal fingerprint and/or the lay-out of the images in the video feed to which the mask is applied and stored in the mask database. In this way, a mask created for a medical unit becomes advantageously available for future use and without the need to create the same mask again. In order to further ensure effective retrieval of the created masks from the database, in a further embodiment, the created masks are stored in the mask database and associated to a user defined type and/or model of medical unit.

In a further embodiment, the user can define and associate at least one label with at least one zone of a mask, which labels are stored in the mask database together with said mask. By preference, each of said labels include user access privilege information and/or the information class pertaining to the content of zone to which said label corresponds. In this way, the user is not left in doubt about which patient information is available and/or which patient information is hidden. This is particularly advantageous in situations where the background of the images of the video feed has the same color as the mask.

In a further embodiment, the step of merging the mask with at least some, preferably all, frames of the video feed happens on a device physically connected to the medical unit. In this way, the un-masked video feed is never transmitted to any other device before being masked, thereby saving bandwidth across the whole videoconference supporting network. Furthermore, this adds a substantial barrier in terms of data security. The unmasked data is not transmitted, only after masking, at which point the obscured data has been irrevocably masked, and is not accessible by anyone in the videoconference.

A second aspect of the invention discloses a system for capturing, processing and transmitting video and audio feed from at least one medical unit to a videoconference, said method comprising:
a. a filtering unit configured for performing step a., b., c. and d. of the method according to any of the preceding claims 1 to 11, wherein said filtering unit comprises a wireless communication module, said wireless communication module configured for wirelessly sharing the merged video feed from step d. in the videoconference, said filtering unit preferably physically connected to the medical unit;
b. optionally an input unit suitable for creating a mask on one or more frames of the video feed received in step a., by manually marking zones to be masked and a display unit for visualizing said one or more frames and said marked zones to be masked.

In a further embodiment, the filtering unit is capable of receiving signals from a medical unit via cable and/or wirelessly. In this way, the system can be used even when physical connection with the medical unit is not possible, such as, but not limited to when the medical unit is located in a clean room. Preferably, the filtering unit is capable of receiving the signals via a direct physical link or connection (i.e., wiredly).

In a further or another embodiment, the filtering unit comprises at least one communication module, which is capable of transmitting a masked signal via cable and/or wirelessly to a videoconference system. Preferably, the filtering unit is capable of transmitting the masked signals wirelessly.

The cables used to connect the medical unit to the system and/or the system to a video conference system can be any cables from a non-exclusive group comprising Coaxial, fiberoptic, twisted pair, SCART, VGA, DVI, RGB, HDMI, USB, FireWire, S/PDIF, AES3, MADI, Display port, HDBaseT, 30-pin connector, Ethernet, Mobile High-Definition Link, Tip-ring connector, five-pin connector, PAL-connector, SDI, composite video, component video, RGBI, XLR.

Any wireless connections used to connect the medical unit to the system and/or the system to a video conference system can be any one or a combination of infrared, radio, microwave, Wi-Fi, 3G, 4G, 5G, 6G, Bluetooth, ultrasoninc, electromagnetic induction, low-power wide area networks, or the like.

However, it is obvious that the invention is not limited to this application. The method according to the invention can be applied in all sorts of devices which produce a video feed.

The invention is further described by the following non-limiting examples which further illustrate the invention, and are not intended to, nor should they be interpreted to, limit the scope of the invention.

### EXAMPLES AND/OR DESCRIPTION OF FIGURES

With as a goal illustrating better the properties of the invention the following presents, as an example and limiting in no way other potential applications, a description of a number of preferred applications of the method capturing, masking and transmitting video feed based on the invention, wherein:

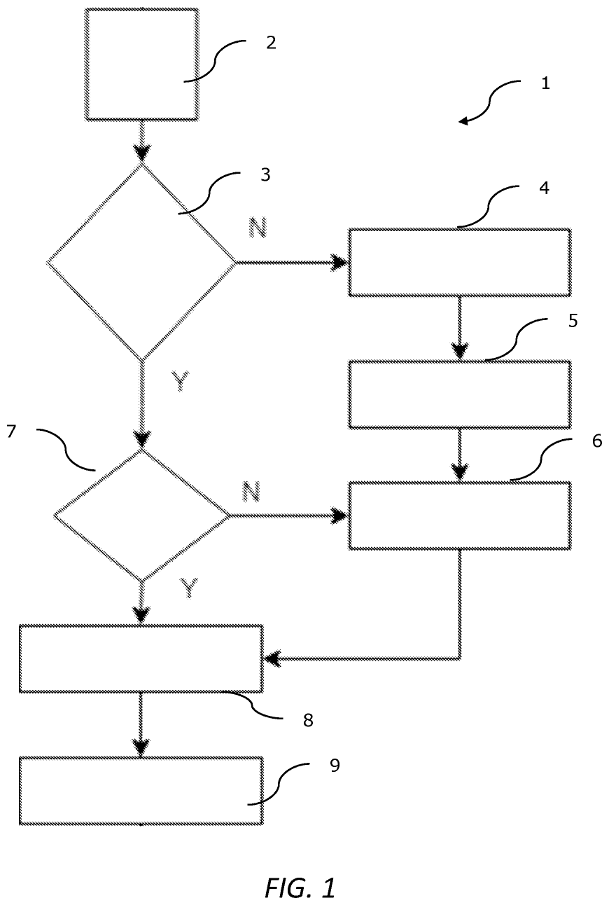

FIG. 1 presents a preferred embodiment of the method capturing, masking and transmitting video feed 1 and its comprising steps. The method 1 starts when a video signal is received 2, said signal is then compared with signal fingerprints stored in a database 3 in order to identify the medical unit 11 providing said signal. Should the signal match any said signal fingerprint and a medical unit 11 identified, a mask database is searched for a mask 7 corresponding to the identified medical unit 11. If no medical unit 11 can be identified, a new file containing a description of the medical unit is created 4. The creation of said medical unit description 4 file can be carried out by the user. Preferably, the creation of said medical unit description 4 file is carried out automatically, after which the user is prompted to fill, at least in part, medical unit specific information. Once a description of the medical unit 4 is made, a recording of the signal fingerprint of the medical unit 11 is made 5, associated with said description and stored into a signal fingerprint database. A mask is then created 6 is created either after recording of the signal fingerprint of the medical unit 5 or if no mask can be found during a search in a mask database 7. Said mask is created by defining, either manually or automatically, at least one text containing zone in at least one, preferably all frames of the video feed. Once a mask is created 6 or found in a mask database 7, a masked feed is created 8 by overlaying said mask over at least one frame, preferably all frames of the video feed provided by the medical unit 11. In a last step, the masked video feed is transmitted 9 to a video conference system.

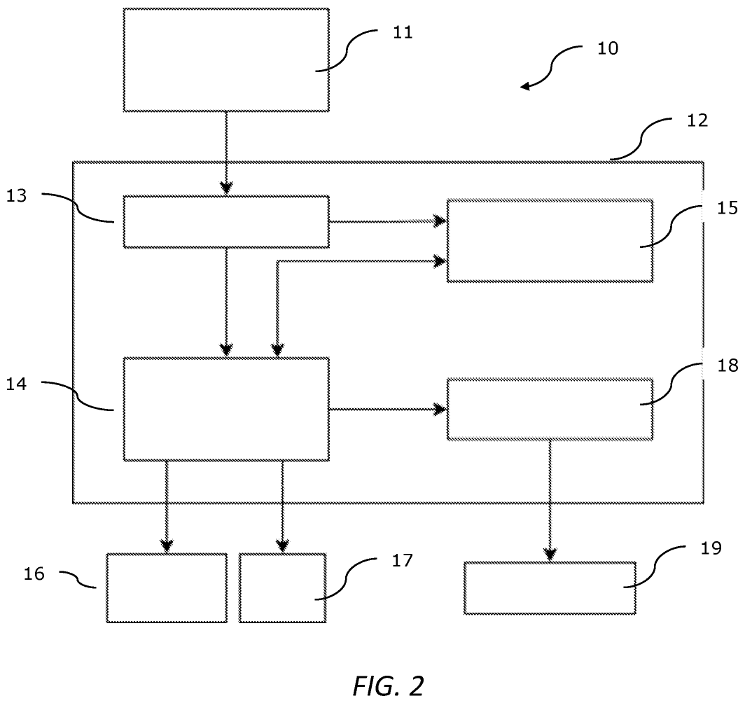

FIG. 2 presents a preferred embodiment of the system for capturing, masking and transmitting video feed 10 and its comprising elements. The figure shows a medical unit 11, a filtering unit 12, a control unit 16, a display unit 17 and a videoconference system 19. The filtering unit 12 is shown as potentially comprising a signal receiver module 13, a processing module 14, a memory 15 and a signal output module 18. The signal receiver module 13 is shown in a connection with the medical unit 11 enabling the reception of a video feed signal provided by said medical unit 11. The signal receiver module 13 is shown with further connections to the processing module 14 (which is or includes a processor programmed to perform the functions described herein) and the memory 15 such that the video feed received by the signal receiver module 13 can either be stored in memory 15, processed directly by the processing module 14, or both. The processing module 14 is shown in connection to the memory 15. This connection primarily provides the processing unit to at least one mask database, at least one medical unit database, and optionally to stored video feeds. The control unit 16 connected to the processing module 14 allows the user to access and edit any database, as well as to create and edit masks while the display unit 17 allows the user to visualize the data being accessed and/or edited. The signal output module or wireless communication module 18 connected to the processing module 14 permits connection with video conference systems 19. Any of the connections between the filtering unit 12 and any other units as shown in this figure may be via cable or wireless connection.

It is clear that the method according to the invention, and its applications, are not limited to the presented examples. For example, the method may include identification of the medical unit by means of a layout analysis of at least one frame of the video feed or by manually inputting information related to the medical unit providing said video feed. In further or other embodiments of the method according to the invention, the user may classify different zones in a mask according to the information masked by said zones. Further or other embodiments of the method may include the definition user access privileges to different zones of a mask. Also, the system shown in FIG. 2 may include further connection between the processing module and/or the signal output module and external servers. In some embodiments of the invention, the memory may be replaced or complemented by at least one memory and/or at least one server.

### LIST OF NUMBERED ITEMS

1 method for capturing, masking and transmitting video feed
2 receiving signal
3 checking database for signal fingerprint
4 creating medical unit description
5 recording signal fingerprint
6 creating mask
7 checking mask database for suitable mask
8 creating mask feed
9 transmitting mask feed
10 system for capturing, masking and transmitting video feed
11 medical unit
12 filtering unit
13 signal receiver module
14 processing module
15 memory
16 control unit
17 display unit
18 wireless communication module or signal output module
19 videoconference system

1. A method for capturing, masking and transmitting video feed from a medical unit in a videoconference with one or more remote users, the method comprising the steps of:
a. receiving a signal via at least one channel from at least one medical unit, the signal comprising at least the video feed, with the video feed comprising patient information;
b. identifying the model and/or type of medical unit;
c. generating or retrieving a mask from a mask database based on the model and/or type information;
d. merging the mask with at least some frames of the video feed; and
e. sharing the merged masked video feed via the videoconference;
wherein the masks are configured for overlaying at least some of the patient information.

2. The method according to claim 1, wherein the step of identifying the model and/or type of medical unit is carried out by comparing a fingerprint of the signal received in step a) with medical unit signal fingerprints stored in a medical unit signal fingerprint database.

3. The method according to claim 1, wherein the step of identifying the model and/or type of medical unit is carried out by analyzing lay-out of images of the video feed.

4. The method according to claim 1, wherein the mask is generated if no explicit model and/or type information for the medical unit is retrieved from the signal and no model and/or type of the medical unit is recognized.

5. The method according to claim 4, wherein generating the mask includes a step of identifying zones containing patient information in a layout of the images in the video feed.

6. The method according to claim 5, wherein the user is requested to carry out the step of identifying the zones containing the patient information in the layout of the images in the video feed by manually drawing bounding boxes around each word, the bounding boxes defining the areas to be masked.

7. The method according to claim 5, wherein the step of identifying the zones containing the patient information in the layout of the images in the video feed is carried out using a computer implemented segmentation algorithm, wherein the algorithm creates bounding boxes around each word, the bounding boxes define the areas to be masked.

8. The method according to claim 5, wherein the mask is associated to a specific signal fingerprint and/or the layout of the images in the video feed to which the mask is applied and stored in the mask database.

9. The method according to claim 5, wherein the mask is stored in the mask database and associated to a user defined type and/or model of medical unit.

10. The method according to claim 9, wherein the user defines and associate at least one label with at least one zone of the mask, wherein the label is stored in the mask database together with the mask.

11. The method according to claim 1, wherein the step of merging the mask with at least some of the frames of the video feed is executed on a device physically connected to the medical unit.

12. The method according to claim 1, wherein the patient information is text-based patient information.

13. The method according to claim 1, wherein the mask is merged with all the frames of the video feed.

14. The method according to claim 1, wherein the sharing includes displaying the merged masked video feed via the videoconference.

15. The method according to claim 1, wherein the masks are configured for overlaying all of the patient information.

16. A system for capturing, masking and transmitting video and audio feed from at least one medical unit to a videoconference, comprising:
a. a filtering unit configured for performing step a., b., c. and d. of the method according to claim 1, wherein the filtering unit comprises a wireless communication module, the wireless communication module configured for wirelessly sharing the merged video feed from step d. in the videoconference, the filtering unit being physically connected to the medical unit;
b. optionally an input unit suitable for creating a mask on one or more frames of the video feed received in step a. by manually marking zones to be masked and a display unit for visualizing the one or more frames and the marked zones to be masked.

17. The system according to claim 16, wherein the filtering unit is configured to receive signals from the medical unit via a direct physical connection.

18. The system according to claim 16, wherein the filtering unit is configured to transmit a masked signal via cable and/or wirelessly to the videoconference system.
